(19) United States
(12) Patent Application Publication
(10) Pub. No.: US 2022/0221657 A1
(43) Pub. Date: Jul. 14, 2022

(54) OPTICAL FIBER END SECURING STRUCTURE AND METHOD OF SECURING OPTICAL FIBER END

(71) Applicant: CLOUD LIGHT TECHNOLOGY LIMITED, Hong Kong (HK)

(72) Inventors: MING-HSING CHUNG, New Taipei City (TW); JEN-KAI TSAI, New Taipei City (TW); JUI-TING TSAI, New Taipei City (TW); CHANG-HUNG TIEN, New Taipei City (TW)

(21) Appl. No.: 17/322,929

(22) Filed: May 18, 2021

(30) Foreign Application Priority Data
Jan. 11, 2021 (TW) 110101015

(51) Int. Cl. G02B 6/38

(52) U.S. Cl. CPC G02B 6/3889

(57) ABSTRACT

An optical fiber end securing structure and a method of securing an optical fiber end are introduced. The optical fiber end securing structure includes a stub component, a substrate and an adhesive component. The stub component is cylindrical. The stub component has axially a through hole for receiving an optical fiber. The substrate has a securing groove. Two walls of the securing groove extend in the axial direction of the stub component. The distance between the two walls is less than the diameter of the stub component in the radial direction. The outer circumferential surface of the stub component is in linear contact with apexes of the two walls. The adhesive component fills the securing groove and connects the securing groove and the stub component. Therefore, the optical fiber end securing structure and the method of securing an optical fiber end enable the optical fiber to undergo high-precision engagement.

### CROSS-REFERENCE TO RELATED APPLICATION

This non-provisional application claims priority under 35 U.S.C. § 119(a) on Patent Application No(s).110101015 filed in Taiwan, R.O.C. on Jan. 11, 2021, the entire contents of which are hereby incorporated by reference.

### BACKGROUND OF THE INVENTION

### 1. Field of the Invention

The present disclosure relates to optical communication components, and in particular to an optical fiber end securing structure and a method of securing an optical fiber end.

### 2. Description of the Related Art

Optical fibers are fibers made of glass or polymer and serve as a light transmission tool whereby light is transmitted along the fibers by total internal reflection. Electrical signals incur less energy loss when transmitted with optical fibers than cables. Referring to FIG. 1, a laser emitting member E converts electrical signals into optical signals, and then the optical signals pass through a lens L before propagating toward one end of an optical fiber F. Then, the optical signals are transmitted along the optical fiber F to the other end thereof. After that, the optical signals exit the optical fiber F and pass through another lens (not shown). Finally, the optical signals are converted into electrical signals with an optical signal receiving member (not shown).

FIG. 2 is a transverse cross-sectional view taken along line A-A of FIG. 1. The conventional optical fiber F is sandwiched between an upper cover C1 and a lower cover C2; they are secured to each other with glue element G1 (such as epoxy resin). The lower cover C2 is mounted on substrate B with glue element G2. As a result, their tolerance accumulate during a manufacturing process and an assembly process. The alignment of the optical fiber F with laser emitting member E and lens L is affected by imprecise component size, location of the coating of glue element G2, overly large thickness of glue elements G1, G2, and the uneven coating of glue elements G1, G2. In case of excessive tolerance, the optical fiber F cannot be optically coupled to the laser emitting member E or lens L, that is, the optical signals cannot be input to the optical fiber F or output from the optical fiber F. Referring to FIG. 3, intensity of the optical signals thus input or output is affected even by partial tolerance.

### BRIEF SUMMARY OF THE INVENTION

An objective of the present disclosure is to provide an optical fiber end securing structure and a method of securing an optical fiber end.

To achieve at least the above objective, the present disclosure provides an optical fiber end securing structure, comprising: a stub component being cylindrical and having axially a through hole for receiving an optical fiber; a substrate having a securing groove, wherein two walls of the securing groove extend in an axial direction of the stub component, and a distance between the two walls is less than a diameter of the stub component in a radial direction, wherein an outer circumferential surface of the stub component is in linear contact with apexes of the two walls; and an adhesive component filled in the securing groove and adapted to connect the securing groove and the stub component.

In an embodiment of the present disclosure, tops of the two walls are right-angled.

In an embodiment of the present disclosure, tops of the two walls are chamfered.

In an embodiment of the present disclosure, tops of the two walls are arcuate and have a smaller radius of curvature than the stub component in a radial direction.

In an embodiment of the present disclosure, the securing groove is formed by etching.

In an embodiment of the present disclosure, the stub component is made of ceramic.

In an embodiment of the present disclosure, the optical fiber end securing structure comprises the optical fiber inserted into the through hole.

The present disclosure further provides a method of securing an optical fiber end, comprising the steps of: grinding a stub component until the stub component becomes cylindrical; moving an optical fiber in an axial direction of the stub component until the optical fiber gets inserted into a through hole of the stub component; forming at least one securing groove on a substrate, wherein a distance between two walls of the securing groove is less than a diameter of the stub component in a radial direction; filling the at least one securing groove with an adhesive component; and positioning the stub component at the securing groove, wherein an outer circumferential surface of the stub component is in linear contact with apexes of the two walls.

Therefore, according to the present disclosure, the optical fiber end securing structure and the method of securing an optical fiber end demonstrates greatly enhanced precision but less tolerance, such that the optical fiber and the other optical components can be accurately aligned to thereby enhance production yield and optical coupling efficiency of optical signals.

### BRIEF DESCRIPTION OF THE DRAWINGS

FIG. 1 (PRIOR ART) is a longitudinal cross-sectional view of a conventional optical fiber end structure.

FIG. 2 (PRIOR ART) is a transverse cross-sectional view taken along line

A-A of FIG. 1.

FIG. 3 (PRIOR ART) is a graph of optical signal intensity versus accumulated tolerance.

FIG. 4 is a perspective view of an optical fiber end securing structure according to an embodiment of the present disclosure.

FIG. 5 is a cross-sectional view of the optical fiber end securing structure according to an embodiment of the present disclosure.

FIG. 6A is a cross-sectional view of the second aspect of the walls according to an embodiment of the present disclosure.

FIG. 6B is a cross-sectional view of the third aspect of the walls according to an embodiment of the present disclosure.

FIG. 6C is a cross-sectional view of the fourth aspect of the walls according to an embodiment of the present disclosure.

FIG. 7 is a schematic view of the process flow of a method of securing an optical fiber end according to an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

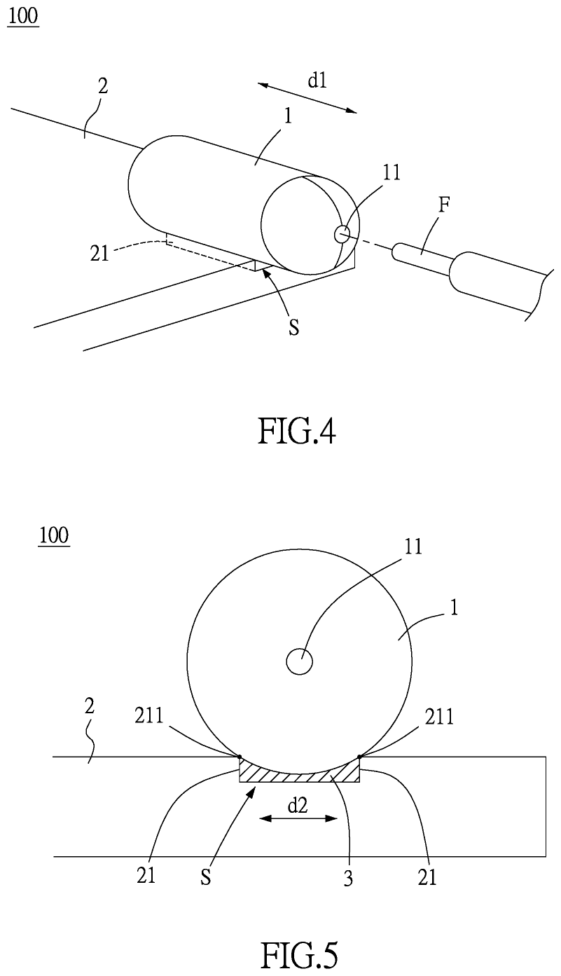

Referring to FIG. 4 and FIG. 5, in an embodiment of the present disclosure, an optical fiber end securing structure 100 comprises a stub component 1, a substrate 2 and an adhesive component 3.

The stub component 1 is a fiber stub and is cylindrical. The stub component 1 has axially a through hole 11 for receiving an optical fiber F. In this embodiment, the stub component 1 is made of ceramic and thus is chemically stable, resistant to grinding, and suitable for high-precision processing.

The substrate 2 has a securing groove S. Two walls 21 of the securing groove S extend in the axial direction d1 of the stub component 1. The distance between the two walls 21 is less than the diameter of the stub component 1 in a radial direction d2. The outer circumferential surface of the stub component 1 is in linear contact with apexes 211 of the two walls 21.

The adhesive component 3 fills the securing groove S. The adhesive component 3 connects the securing groove S and the stub component 1. The adhesive component 3 is a standard adhesive and is adhesive. After satisfying specific criteria (such as being dried or being exposed), the adhesive component 3 is cured with a view to securing the stub component 1.

The method of securing an optical fiber end according to the present disclosure is described below.

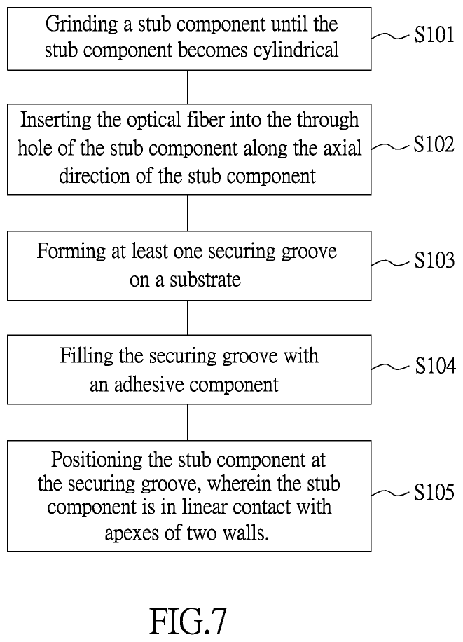

Referring to FIG. 7, step S101 entails grinding the outer circumferential surface of the stub component 1 until the stub component 1 becomes cylindrical.

In step S102, the optical fiber F is moved in the axial direction d1 of the stub component 1, so as to be inserted into the through hole 11 of the stub component 1.

In step S103, at least one securing groove S is formed on the substrate 2.

The distance between the two walls 21 of the securing groove S is less than the diameter of the stub component 1 in a radial direction d1. In this embodiment, the securing groove S is formed by etching to thereby attain high-precision control and be hundreds of microns in dimensions.

In step S104, the securing groove S is filled with the adhesive component 3.

In step S105, the stub component 1 is disposed at the securing groove S, and the outer circumferential surface of the stub component 1 is in linear contact with the apexes 211 of the two walls 21.

The aforesaid steps do not necessarily take place in the aforesaid sequence. For instance, the step of forming the securing groove S on the substrate 2 can precede the step of grinding the stub component 1 and the step of inserting the optical fiber F into the through hole 11. Alternatively, the step of inserting the optical fiber F into the through hole 11 is followed by the step of grinding the stub component 1.

Alternatively, the step of positioning the stub component 1 at the securing groove S is followed by the step of inserting the optical fiber F into the through hole 11. Therefore, the aforesaid sequence is not restrictive of the present disclosure.

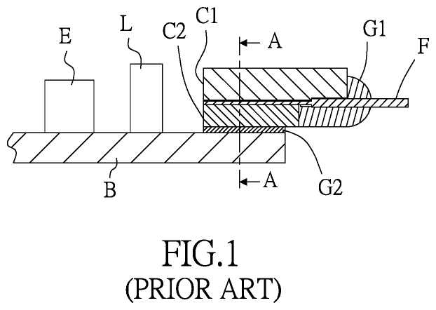

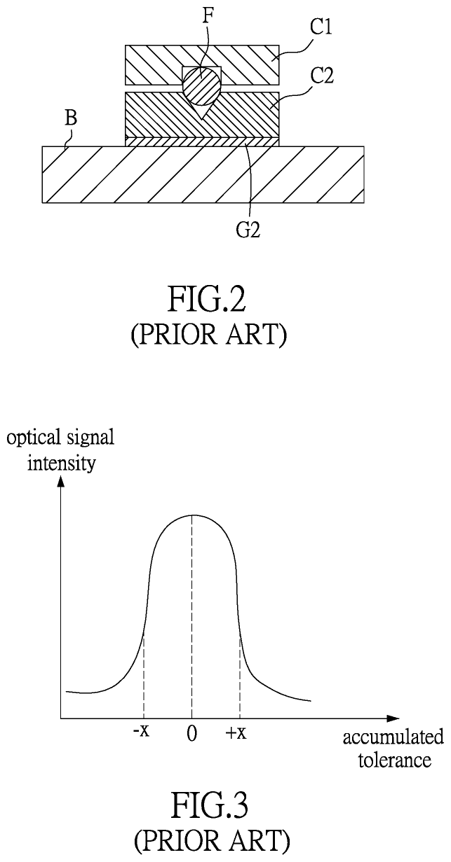

It is easier to produce, by high-precision manufacturing, the cylindrical stub component 1 than an end securing elements of any other geometrical shapes (such as the conventional upper cover C1 and lower cover C2 of FIG. 1). Thus, the tolerance of the stub component 1 can be effectively controlled. In addition, the through hole 11 axially formed in a cylinder is of higher precision than an optical fiber receiving groove formed by cutting at a specific point and of any other geometrical shapes. Thus, compared with the prior art, the present disclosure achieves less tolerance in fitting the stub component 1 and the optical fiber F together. Furthermore, the outer circumferential surface of the stub component 1 is in linear contact with the apexes 211 of the securing groove S; hence, regardless of the angle by which the stub component 1 rotates during an adhesion process (for example, the force exerted by a robotic arm on the stub component 1 while gripping it is uneven), both the through hole 11 and the optical fiber F keep staying at the securing position, such that the optical fiber F and a lens (not shown) can be accurately aligned. Therefore, according to the present disclosure, the optical fiber end structure demonstrates greatly enhanced precision but less tolerance, such that the optical fiber F and the other optical components can be accurately aligned to thereby enhance production yield and optical coupling efficiency of optical signals.

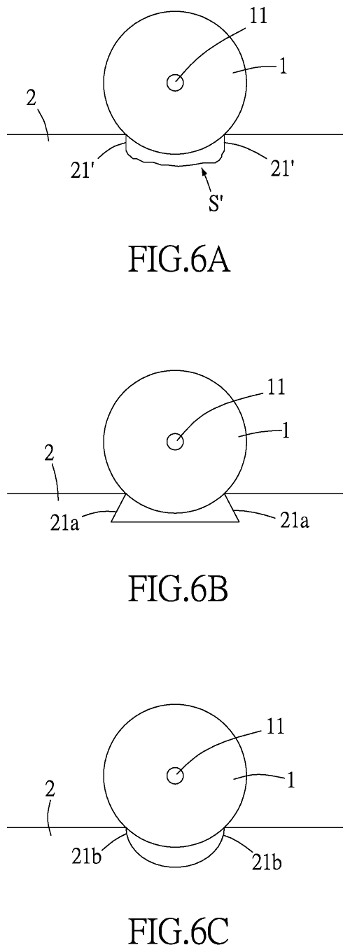

In this embodiment, as shown in FIG. 5, the tops of the two walls 21 are right-angled, whereas the securing groove S is rectangular space. However, the present disclosure is not limited thereto. Referring to FIG. 6A, in the second aspect of the walls, the tops of walls 21′ are right-angled, but the other parts of the walls 21′ are of irregular shape or of any other geometrical shapes, not to mention that the bottom surface of the securing groove S′ is not flat. This phenomenon is typical of an etching process. Since the stub component 1 is in linear contact with the apexes 211 of the securing groove S, the shape of the walls, except for the parts other than the tops of the walls, does not affect the connection of the stub component 1 and the securing groove S.

Referring to FIG. 6B, in the third aspect of the walls, the tops of the two walls 21a are chamfered. Thus, the stub component 1 is in linear contact with the apexes 211 of the securing groove S. However, not only are the chamfered tops difficult to manufacture, but their structural strength is also inadequate.

Referring to FIG. 6C, in the fourth aspect of the walls, the tops of the two walls 21b are arcuate and have a smaller radius of curvature than the stub component 1 in a radial direction d2. Thus, the stub component 1 is in linear contact with the apexes 211 of the securing groove S.

In this embodiment, the optical fiber end securing structure 100 of the present disclosure comprises the optical fiber F inserted into the through hole 11.

While the present disclosure has been described by means of specific embodiments, numerous modifications and variations could be made thereto by those skilled in the art without departing from the scope and spirit of the present disclosure set forth in the claims.

1. An optical fiber end securing structure, comprising:
a stub component being cylindrical and having axially a through hole;
an optical fiber, wherein the end of the optical fiber is positioned at the through hole;
a substrate having a securing groove, wherein two walls of the securing groove extend in an axial direction of the stub component, and a distance between the two walls is less than a diameter of the stub component in a radial direction, wherein an outer circumferential surface of the stub component is in linear contact with apexes of the two walls; and
an adhesive component filled in the securing groove and adapted to connect the securing groove and the stub component.

2. The optical fiber end securing structure of claim 1, wherein tops of the two walls are right-angled.

3. The optical fiber end securing structure of claim 1, wherein tops of the two walls are chamfered.

4. The optical fiber end securing structure of claim 1, wherein tops of the two walls are arcuate and have a smaller radius of curvature than the stub component in a radial direction.

5. The optical fiber end securing structure of claim 1, wherein the securing groove is formed by etching.

6. The optical fiber end securing structure of claim 1, wherein the stub component is made of ceramic.

7. (canceled)

8. A method of fixing an optical fiber end in place, comprising the steps of:
grinding a stub component until the stub component becomes cylindrical;
moving an optical fiber in an axial direction of the stub component until the optical fiber gets inserted into a through hole of the stub component so that the end of the optical fiber is positioned in the through hole;
forming at least one securing groove on a substrate, wherein a distance between two walls of the securing groove is less than a diameter of the stub component in a radial direction;
filling the at least one securing groove with an adhesive component; and
positioning the stub component at the securing groove, wherein an outer circumferential surface of the stub component is in linear contact with apexes of the two walls.
